(19) United States
(12) Patent Application Publication
(10) Pub. No.: US 2025/0020597 A1
(43) Pub. Date: Jan. 16, 2025

(54) SYSTEMS AND METHODS OF IMAGE EXTRACTION FOR EFFECTIVE GLOBAL AND LOCAL DAMAGE ASSESSMENT

(71) Applicant: Government of the United States, as represented by the Secretary of the Air Force, Wright-Patterson AFB, OH (US)

(72) Inventors: Jie Wei, Wappingers Falls, NY (US); Weicong FENG, Staten Island, NY (US); Alexander AVED, Rome, NY (US); Erik BLASCH, Arlington, VA (US); Erika G. ARDILES CRUZ, New Hartford, NY (US); Paul Thomas Schrader, Clinton, NY (US)

(21) Appl. No.: 18/768,214

(22) Filed: Jul. 10, 2024

Related U.S. Application Data
(60) Provisional application No. 63/513,156, filed on Jul. 12, 2023.

(51) Int. Cl. G01N 21/88; G06T 7/00; G06T 7/12; G06V 10/25; G06V 10/764

(52) U.S. Cl. CPC G01N 21/8851; G06T 7/0008; G06T 7/12; G06V 10/25; G06V 10/764; G01N 2021/8854; G06T 2207/10024

(57) ABSTRACT

A system and method for prior and post-image analysis for damage level assessments are provided. An Image-based Prior and Posterior Conditional Probability Learning (IP2CL) system and method is provided for Human Assistance and Disaster Response (HADR) and damage assessments (DA) situational assessment and awareness (SAA). Equipped with the IP2CL, matching prior and posterior disaster/action images are effectively encoded into one image which is then ingested into deep learning (DL) approaches to determine the damage levels. Two scenarios for practical uses are provided: pixel-wise semantic segmentation and patch-based global damage classification.

Pursuant to 37 C.F.R. § 1.78(a)(4), this application claims the benefit of and priority to prior filed co-pending Provisional Application Ser. No. 63/513,156, filed Jul. 12, 2023, which is expressly incorporated herein by reference.

### RIGHTS OF THE GOVERNMENT

The invention described herein may be manufactured and used by or for the Government of the United States for all government purposes without the payment of any royalty.

### FIELD OF THE INVENTION

The system and method described herein generally to relate imagery information extraction and analysis, and more particularly to prior and post-image analysis for damage level assessments.

### BACKGROUND OF THE INVENTION

Effective Human Assistance and Disaster Response (HADR) requires accurate Situational Assessment and Awareness (SAA). HADR SAA is challenging because often a catastrophic event is typically without prior exemplars from which resolved damage levels offer near real-time (NRT) response. Effectively, the HADR situation resembles a battlefield requiring critical region monitoring and surveillance, prompt and accurate damage assessments (DA), robust operating conditions assessment, and knowledge of highly dangerous and contested scenarios. In all these situations, manual evaluations and labeling by human experts for prompt and real-time damage level assessments for the target of interest (TOI) region are more often than not intractable and unscalable. A key contribution to these obstacles is that the manual labeling process is extremely labor-intensive and time-consuming since each location in the TOI region must be thoroughly studied to decide the correct labeling category wherein significant expertise on the object types and damage styles is needed. This can be catastrophic for major disasters/actions over a wide area prohibiting effective HADR or DA efforts. To mitigate these concerns, cutting-edge hardware, such as a graphics processing unit (GPU) and high-performance computing (HPC), and software, such as Artificial Intelligence and Machine Learning (AI/ML), especially the deep learning (DL) approaches must be leveraged. Furthermore, to render the work for practical utility, the method should be both data and computationally efficient because 1) the available data for HADR and DA applications are often sparse prohibiting effective DL model training, and 2) the HADR personnel may not have onsite access to high-performance computing in their missions.

The challenges for HADR/DA solutions include the data, damage assessment levels, and analytical approaches.

With respect to data, the images, taken by satellites or aerial vehicles, of the prior and post-disaster/action for the TOI, are normally available, well registered, and matched, such as the XView2 datasets (https://xview2.org/) from the U.S. Department of Defense's Defense Innovation Unit Experimental (DIUx). To analyze the matching images and the corresponding masks, traditional image-based deep nets cannot be used directly. Alternatively, the user must employ contrastive learning to take the prior and post images at the same time to extract the outstanding features of the foreground regions. This methodology does not fully leverage the deep nets which are generally based on sets of single images.

With respect to damage assessment, current human annotation is generally scaled categorically as “no damage”, “minor damage”, “major damage”, and “total damage” which can vary based on the subject matter expert assessment or consensus.

With respect to analytical approaches or methodology, there are several issues. First is a lack of viable existing data. The available image data with perfectly matched prior and post disasters/actions is minimal and generating ground truths for different disaster types is labor intensive. Second is algorithmic difficulty. The innate two-image inputs make the use of most existing deep nets unviable, where single images are used to train the different architectures of various deep networks. The only existing deep net that can readily be employed for two-image inputs is contrastive learning, which, due to the sparseness of foreground regions and lack of sufficient attention yields inadequate classification performance to given TOIs.

Therefore, a need exists for a novel solution to reasonably combat these challenges to achieve DA/HADR objectives for prior and post-disaster/actions and an innovative representation is needed to effectively encode the prior and post-disaster information and facilitate high-performance DA which leverages state-of-the-art DL paradigms synergistically.

### SUMMARY OF THE INVENTION

The system and method described herein generally to relate imagery information extraction and analysis, and more particularly to prior and post-image analysis for damage level assessments.

While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention, a system for assessing infrastructure damage of a target of interest region is provided. The system comprises:
a) a computing device configured to run an Image-based Prior and Posterior Conditional Probability (IP2CP) formulation to formulate conditional probabilities in the form of a normalized color image for global and local patch damage assessment work;
b) an IP2CP training module that is configured to ingest a collection of prior images and post images of the target of interest region, and then perform supervised deep learning (DL) multi-classification tasks under a prescribed random train/test split, said IP2CP training module providing an output;
c) an IP2CP application module that is configured to apply the IP2CP formulation using the output of the IP2CP training module to a given target of interest region, said IP2CP application module providing an output; and
d) an IP2CP local patch contrastive module that provides local patch damage level assessment of the given target of interest region based upon the output of the IP2CP application module.

In another embodiment, a method for assessing infrastructure damage of a target of interest region is provided. The method comprises:
a) obtaining a first image X of the target of interest region that is prior to a damage causing event, said first image having a first background;
b) obtaining a second image Y of the target of interest region that is after a damage causing event, wherein the second image is a matching image of the target of interest region, said second image having a second background;
c) encoding the differences and importance of the target of interest region into a single image Z; and
d) using deep learning for single image segmentation and classification to assess damage to the target of interest region.

The system and method described herein provide a new representation of Image-based Prior and Posterior Conditional Probability (IP2CP) for global and local damage level assessment.

These and other aspects of the embodiments herein will be better appreciated and understood when considered in conjunction with the following description and the accompanying diagrams. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a block diagram showing one embodiment of the Image-based Prior and Posterior Conditional Probability (IP2CP) formulation module used in this system.

FIG. 2 is a block diagram showing one embodiment of the IP2CP training module using IP2CL as formulated in FIG. 1.

FIG. 3 is a block diagram showing one embodiment of the IP2CP damage application module using the IP2CL formulation shown in FIG. 1 and the trained model illustrated in FIG. 2.

FIG. 4 is a block diagram showing one embodiment of the IP2CP local patch contrastive module to be used for local patch damage level assessment.

FIG. 5A is an aerial photo showing a pre-disaster target of interest (TOI) region.

FIG. 5B is an aerial photo showing the TOI region in FIG. 5A, post disaster.

FIG. 5C is a ground truth damage mask of the target of interest using the method of the present invention, which in this case, are the buildings in the TOI region.

FIG. 5D is the IP2CP image corresponding to the FIGS. 5A, 5B, and 5C.

FIG. 6A is a first sample local patch with no damage in the TOI region that is used to train the contrastive learning net in the method described herein.

FIG. 6B is a second sample local patch with no damage in the TOI region that is used to train the contrastive learning net in the method described herein.

FIG. 6C is a first sample local patch with damage designations in the TOI region that is used to train the contrastive learning net in the method described herein.

FIG. 6D is a second sample local patch with damage designations in the TOI region that is used to train the contrastive learning net in the method described herein.

### DETAILED DESCRIPTION OF THE INVENTION

The system and method described herein generally to relate imagery information extraction and analysis, and more particularly to prior and post-image analysis for damage level assessments.

Embodiments of the disclosed invention, its various features, and the advantageous details thereof, are explained more fully with reference to the non-limiting embodiments that are illustrated in the accompanying drawings and detailed in the following description. Descriptions of well-known components and processing techniques are omitted to not unnecessarily obscure what is being disclosed. Examples may be provided, and when so provided are intended merely to facilitate an understanding of how the invention may be practiced and to further enable those of skill in the art to practice its various embodiments. Accordingly, examples should not be construed as limiting the scope of what is disclosed and otherwise claimed.

The system and method utilize a Dynamic Data Driven Applications System (DDDAS) approach for near real-time (NRT) situations in which the DL-trained model is updated from continuous learning through effective labeling of Situational Assessment and Awareness (SAA) updates. To accomplish the NRT deep learning (DL) within DDDAS, the present invention provides an Image-based Prior and Posterior Conditional Probability Learning (IP2CL) system that is based on ground damage level assessment for a specific target domain. Equipped with the IP2CL system, the matching pre- and post disaster/action images are effectively encoded into one image that is then learned using DL approaches to determine the damage levels.

The system and method described herein extract and assign types to the damage level assessments of the objects in the imagery. The system and method may be used in many situations including, but not limited to in Human Assistance and Disaster Response (HADR) applications such as first response actions, as well as law enforcement, intelligence, security, and defense applications.

For the IP2CL deployable system, three components are provided. The first component is the IP2CP formulation module, which formulates the conditional probabilities, in the form of a normalized color image, to carry the most valuable information in the prior and post-disaster/action images for the TOI region. IP2CL serves as the foundation for the ensuing global and local patch damage level assessment work. The second component is a semantic segmentation damage assessment procedure for images covering a wide expanse with possibly many TOIs. The third component is a global patch-based damage classification procedure to classify image patches centered on a TOI of special interest.

The term “target of interest (TOI)”, as used herein, is a target-centric, background subtracted sub-image of a prior and post-event image. A target of interest (TOI) is typically, but not limited to, a man-made structure (e.g., houses, buildings) or ground-based mechanisms (e.g., vehicles, military assets, ships in port) within a region, known as the TOI region, such as urban/rural communities and their surrounding natural environment. The term “TOI region”, as used herein, refers to the complete prior and post-event images including a TOI's background. An event associated to the TOI and its region is, but not limited to, the target's damage response from a natural disaster based force (e.g., wind shear, seismic vibration) or kinetic battle damage (e.g., explosive/impact forces).

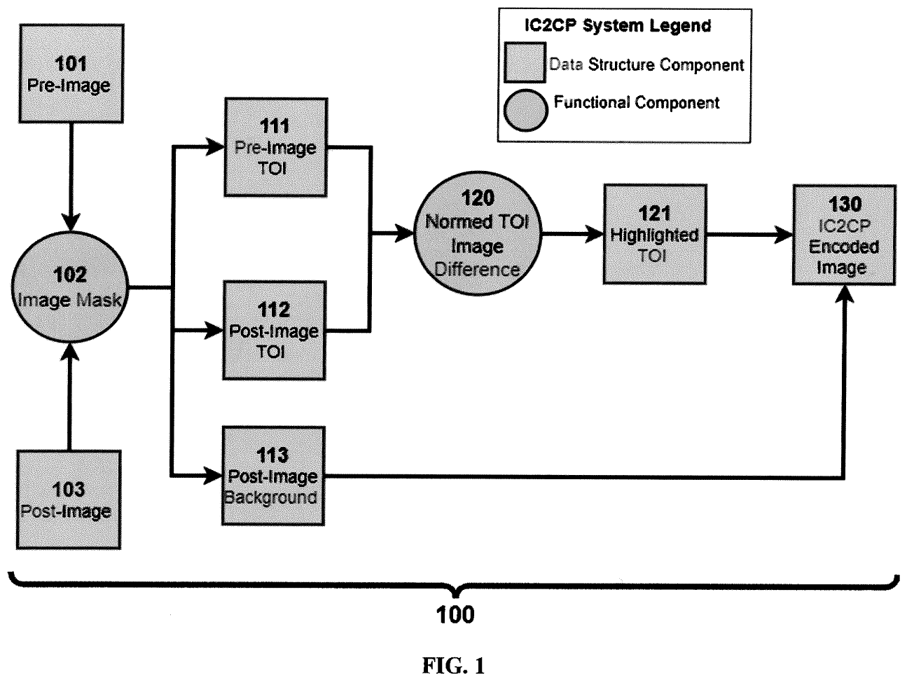

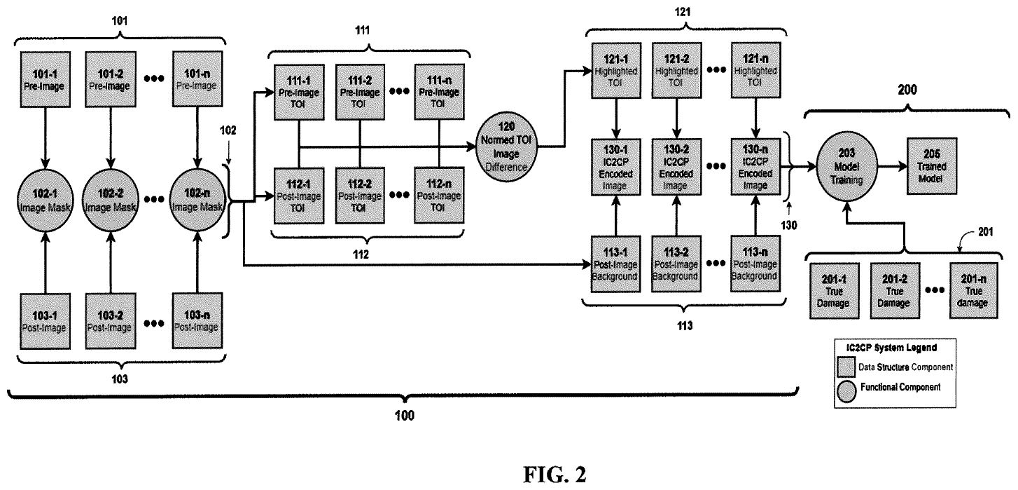

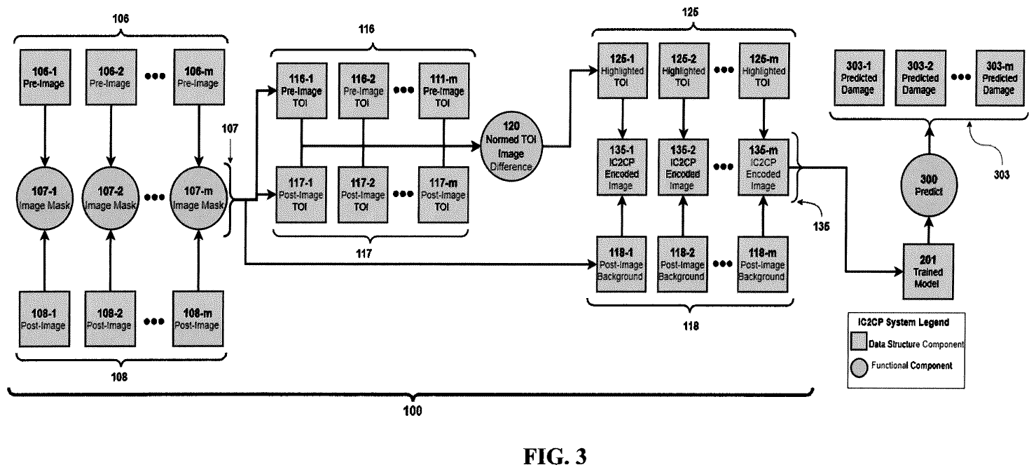

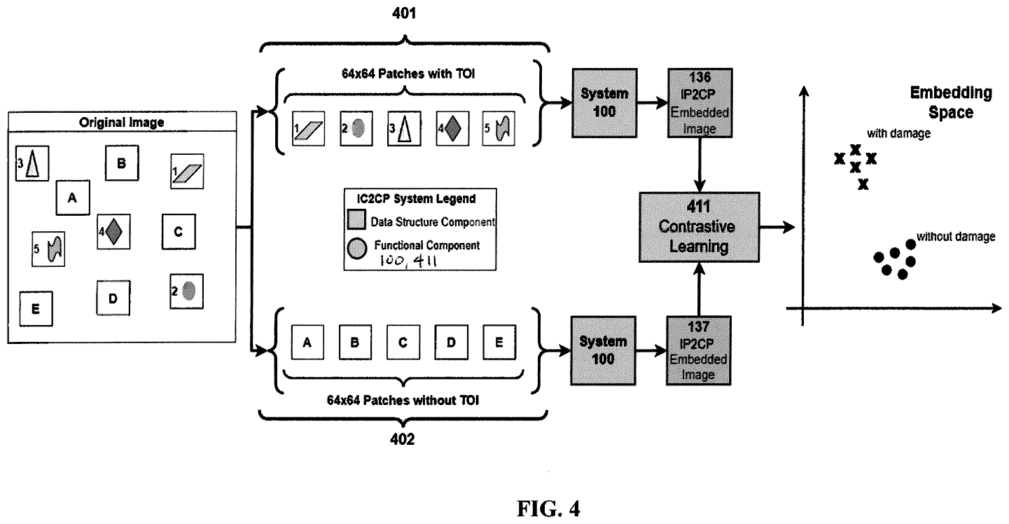

Referring now to the drawings, and more particularly to FIGS. 1-4, there is shown an exemplary embodiment of the system and method of the present invention. More specifically, FIG. 1 is the typical embodiment of the IP2CP formulation module. FIGS. 2 and 3 are the typical embodiments of the semantic segmentation damage assessment procedure which are shown as an IP2CP-based training module in FIG. 2 and an IP2CP-based damage assignment module in FIG. 3. FIG. 4 is the typical embodiment of the global patch-based damage classification procedure.

The various modules and corresponding components described herein and/or illustrated in the figures may be embodied as hardware-enabled modules and may be a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that include electronic circuits process computer logic instructions capable of providing digital and/or analog signals for performing various functions as described herein. The various functions can further be embodied and physically saved as any of data structures, data paths, data objects, data object models, object files, and database components. For example, the data objects could include a digital packet of structured data. Example data structures may include any of an array, tuple, map, union, variant, set, graph, tree, node, or object, which may be stored and retrieved by computer memory and may be managed by processors, compilers, and other computer hardware components. The data paths can be part of a computer CPU or GPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be physical locations in computer memory and can be a variable, a data structure, or a function. The database components can include any of the tables, indexes, views, stored procedures, and triggers.

Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. The embodiments herein can include both hardware and software elements. The embodiments that are implemented in software include but are not limited to, firmware, resident software, microcode, etc.

FIG. 1 is a block diagram illustrating from left to right an IP2CP formulation module which will be denoted as system 100. The module ingests a prior image before an event producing potential damage. The “event producing potential damage” can be abbreviated as F. This prior image is represented as an image data structure of a target of interest and is denoted as Pre-Image 101. Simultaneously, the module also ingests a posterior image data representation of the same domain after E, denoted as Post-Image 103, into a prescribed Image Mask 102. The Pre-Image 101 and Post-Image 103 data structures can contain representations of one or more images of the desired domain. The precise organization of this multiple-image version of Pre-Image 101 and Post-Image 103 along with how it affects further derived data structures in the IP2CP formulation module are detailed in FIGS. 2 and 3. The Image Mask 102 is applied to Pre-Image 101 and isolates the pre-image target of interest (TOI) data structure, denoted in FIG. 1 as Pre-Image TOI 111, from the remaining background of the given Pre-Image 101. Simultaneously, the Post-Image 103 data structure is filtered by the Image Mask 102 generating the Post-Image TOI 112 and Post-Image Background data structures 113. The remaining background data of the Pre-Image 101 and Post-Image 103 outside their respective Pre-Image TOI 111 and Post-Image TOI 112 are stored in the Image Mask 102 functional component. There these backgrounds of the Pre-Image 101 outside the Pre-Image TOI 111 and Post-Image 103 outside the Pre-Image TOI 112 are “sorted” using a probabilistic process described hereinafter. In effect, this action of the Image Mask 102 functional component passes only the post-image background data structure to the Post-Image Background data structure component 113.

Next, both the Pre-Image TOI 111 and Post-Image TOI 112 data structures are ingested into the Normed TOI Image Difference functional component 120. Within the Normed TOI Image Difference functional component 120, the Pre-Image TOI 111 image data structure is first subtracted from the Post-Image TOI 112 image data structure, and the resulting difference is normalized producing the Highlighted TOI image data structure 121.

Finally, the Post-Image Background data 113 is combined with Highlighted TOI 121 to yield the IP2CP Encoded Image data structure 130. The image data structures file formatting processed through system 100 is necessarily consistent for compatibility in the resulting encoded images but can include such file formats as .png, .jpg, .tiff, .gif, etc.

The Image-based Prior and Posterior Conditional Probability Learning system (IP2CL) can be described as generating image Z from a pre-image X and a post-image Y. For the following discussion, the subscript 0 is used for background, and 1 is used for TOI, as image indicators in their respective variable representations. Mathematically, the IP2CP formulation module as depicted in FIG. 1 generates images Z₁∈Highlighted TOI data structure 121 from the normed difference of pre-TOI images X₁∈Pre-Image TOI 111 and post-TOI images Y₁∈Post-Image TOI 112. In addition, the background of the pre- and post-images X₀, Y₀∈Image Mask 112 are “probabilistically sorted” such that Z₀=Y₀ and Z₀∈Post-Image Background 113. Then a final combined images Z₀+Z₁=Z∈IP2CP Encoded Image data structure 130 is constructed. All these image elements are viewed as random variables with the following set of two conditional probability formulas:

$$P ( {Z}_{0} \vert {X}_{0} , {Y}_{0} ) = {Y}_{0} \qquad ( 1 )$$

$$P ( {Z}_{1} \vert {X}_{1} , {Y}_{1} ) = Norm ( {Y}_{1} - {X}_{1} ) \qquad ( 2 )$$

So, for X_{c} and Y_{c}, where c∈{0,1}, the pre- and post-images have pixel values in the range [0,1] when c=1 since they are normalized. When c=0 the pre and post-image backgrounds pixel value range remains fixed from the original ingested pre- and post-images. Equation (1) tells us that given a mixed collection of X₀, Y₀∈Image Mask 112, then the probability that Z₀ will be chosen to be Y₀, or a post-image background, is certain. Furthermore, Z₁, is the new random variable of the same range as X₁ and Y₁. The Norm (w), where w∈Y₁−X₁, denotes the action in Normed TOI Image Difference functional component 120 in FIG. 1 is defined as:

$$Norm ( w ) = \frac{w}{max ( w ) - min ( w )} \qquad ( 3 )$$

Equation (3) transforms the random variable of the pixel to the normalized range of [0,1]. Eqs. (1, 2, 3) essentially generate a new image Z∈IP2CP Encoded Image data structure 130 whose background comes from the post image and the TOI is the normalized version of the difference in the TOI region. Using Equation (3), the pixel-wise differences in the TOI are stressed as a normalized value.

There are several benefits of using image Z instead of the original images X or Y. (It should be understood, however, that these benefits need not be required unless they are set forth in the appended claims.) A first benefit is data and computing efficiency. Faithfully representing two color images as an aggregated single color image the IP2CP effectively reduces the data and computing loads. A second benefit is increased variance of deep learning DL methods that can be used. With three channels (red, green, blue (RGB)), damage level assessment methods have a broader range of DL choices to employ than contrastive learning or 6-channel deep nets for data classification, semantic segmentation, and image/object classification. A third benefit is emphasis on the target of interest (TOI): the TOI regions have larger values and variances yielding classification prioritization. A fourth benefit is simulation of human annotation. In manual labeling by human experts, the pixel-wise difference in TOI plays an important role in making the damage level assessment. The system and method provide improvements relative to manual labeling. A fifth benefit is contextual information: the post-images provide the most relevant contextual information to the TOI assessment as post-disaster and first-responder actions carry more calculational weight on the TOI than the pre-images.

For damage level assessment purposes, two IP2CP-based procedures as illustrated in FIGS. 2 and 3 are needed: model creation and model application.

FIG. 2 is a block diagram for IP2CL representing a second embodiment of the IP2CP-based formulation module shown in FIG. 1, read from left to right. FIG. 2 follows the algorithmic workflow of FIG. 1 as in system 100, but details precisely the organizational structure of how to ingest/process finitely many images n, where n is some positive finite integer. Starting on the leftmost portion of FIG. 2, it begins by ingesting a collection of prior images before an event producing potential damage E. These prior images are represented as image data structures of a domain of interest, denoted as Pre-Image 101-1, Pre-Image 101-2, . . . , Pre-Image 101-n, or more succinctly pre-image collection 101, and fed into a collection of associated image masks Image Mask 102-1, Image Mask 101-2, . . . , Image Mask 102-n, or image mask collection 102. Simultaneously, it ingests a collection of posterior images after E, represented as image data structures of the domain of interest, denoted as Post-Image 103-1, Post-Image 103-2, . . . , Post-Image 103-n, or more succinctly post-image collection 103, into image mask collection 102.

For each Pre-Image 101-i and Post-Image 103-i where 1≤i≤n, the corresponding Image Mask 102-i, isolates the TOI pre-image and post-image from their corresponding backgrounds. That is, for each i where 1≤i≤n, the pre-image TOI data structure from each Pre-Image data structure 101-i is stored in the Pre-Image TOI data structure 111-i of the pre-image TOI collection 111 and the post-image data structure is stored in the Post-Image TOI 112-i of the post-image TOI collection 112. Concurrently, for each same i, the isolated background of the pre- and post-image data structures are probabilistically sorted using Equation (1) in their respective Image Mask 102-i functional component of 102 such that only post-image backgrounds are sent to the corresponding Post-Image Background data structures 113-i, denoted as post-image background collection 113.

Next, for each i in Pre-Image TOI 111 and Post-Image TOI 112, those data structures are passed to the Normed TOI Image Difference functional component 120. There, for each i in Pre-Image TOI 111 and Post-Image TOI 112, Equations (2,3) are applied producing a corresponding i in the highlighted TOI data structure collection 121. That is, to produce Highlighted TOI 121-1, the algorithm first takes the difference as defined in Equation (2) subtracting Pre-Image TOI 111-1 from Post Image TOI 112-1, then applies the Norm function defined in Equations (2,3) producing the Highlighted TOI 121-1 data structure in 121. To produce Highlighted TOI 121-2, the algorithm first takes the difference as defined in Equation (2) subtracting Pre-Image TOI 111-2 from Post Image TOI 112-2, then applies the Norm function defined in Equations (2,3) producing the Highlighted TOI 121-2 data structure in 121. To produce Highlighted TOI 121-n, the algorithm first takes the difference as defined in Equation (2) subtracting Pre-Image TOI 111-n from Post Image TOI 112-n, then applies the Norm function defined in Equations (2,3) producing the Highlighted TOI 121-n data structure in 121. Then for each i, 1≤i≤n, in Highlighted TOI image data structure 121, the algorithm combines each 121-i Highlighted TOI with its corresponding 113-i Post-Image Background producing the IC2CP Encoded Image data structure collection 130=IC2CP Encoded Image 130-1, IC2CP Encoded Image 130-2, . . . , IC2CP Encoded Image 130-n.

Then the IC2CP Encoded Image data structure collection 130 is ingested into a Model Training functional component 203 which performs supervised deep learning (DL) multi-classification tasks under a prescribed random train/test split. Additionally, for each i, 1≤i≤n, the corresponding validated true damage level data collection 201=True Damage 201-1, True Damage 201-2, . . . , True Damage 201-n act as the ground truth labels for this DL process. The classes used in the ground truths for training are the current human annotation scaled categorically as “no damage”, “minor damage”, “major damage”, and “total damage” Finally, under model training process 200, the trained DL model is produced and its structural blueprint is stored in Trained Model component 205 which, as a validated DL model under prescribed high fidelity industry-standard user confidence metrics (e.g., accuracy, precision, recall, F1 scoring of at least 0.9), can be used to autonomously simulate the following current human annotations classifiers: “no damage”, “minor damage”, “major damage”, and “total damage” for further predictive tasking in DA or HADR.

FIG. 3 is a block diagram of the IP2CP damage application module illustrating how the IP2CP-based model trained as shown in FIG. 2 is applied to predict the damage level of given images. Here m is a positive integer value that is not necessarily equal to n in FIG. 2. FIG. 3 follows the key organizational designs of system 100 in FIG. 2 for multiple image ingestion but on a unique collection of pre- and post-images. Starting on the leftmost portion of FIG. 3, the module begins by ingesting a collection of prior images before an event producing potential damage, which may be abbreviated as E′. These prior images are represented as image data structures of a domain of interest, denoted as Pre-Image 106-1, Pre-Image 106-2, . . . , Pre-Image 106-m, or more succinctly pre-image collection 106. The pre-image collection 106 is fed into a collection of associated image masks Image Mask 107-1, Image Mask 107-2, . . . , Image Mask 107-m, or image mask collection 107. Simultaneously, the module ingests a collection of posterior images after E′, represented as image data structures of the domain of interest, denoted as Post-Image 108-1, Post-Image 108-2, . . . , Post-Image 108-m, or more succinctly post-image collection 108, into image mask collection 107. For each Pre-Image 106-i and Post-Image 108 where 1≤i≤m, the corresponding Image Mask 107-i, isolates the TOI pre-image and post-image from their corresponding backgrounds.

That is, for each i where 1≤i≤m, the pre-image TOI data structure from each Pre-Image 106-i data structure is stored in the Pre-Image TOI 116-i data structure of the pre-image TOI collection 116 and the post-image data structure is stored in the Post-Image TOI 117-i of the post-image TOI collection 117. Concurrently, for each same i, the isolated background of the pre- and post-image data structures are probabilistically sorted using Equation (1) in their respective Image Mask 107-i functional component of 107 such that only post-image backgrounds are sent to the corresponding post-image background, Post-Image Background data structures 118-i, denoted as post-image background collection 118.

Next, for each i in pre-image TOI collection 116 and post-image TOI collection 117, those data structures are passed to the Normed TOI Image Difference functional component 120. There, for each i in pre-image TOI collection 116 and post-image TOI collection 117, Equations (2,3) are applied producing a corresponding i in the highlighted TOI data structure collection 125. That is, to produce Highlighted TOI 151-1, the algorithm first takes the difference as defined in Equation (2) subtracting Pre-Image TOI 116-1 from Post Image TOI 117-1, then applies the Norm function defined in Equations (2,3) producing the Highlighted TOI 125-1 data structure in 125. To produce Highlighted TOI 125-2, the algorithm first takes the difference as defined in Equation (2) subtracting Pre-Image TOI 116-2 from Post Image TOI 117-2, then applies the Norm function defined in Equations (2,3) producing the Highlighted TOI 125-2 data structure in 125. To produce Highlighted TOI 125-m, the algorithm first takes the difference as defined in Equation (2) subtracting 116-m Pre-Image TOI from 117-m Post Image TOI, then applies the Norm function defined in Equations (2,3) producing the Highlighted TOI data structure 125-m in 125.

Then for each i, where 1≤i≤m, in the highlighted TOI data structure collection 125, the algorithm combines each Highlighted TOI 125-i with its corresponding Post-Image Background 118-i producing the IC2CP Encoded Image data structure collection 135=IC2CP Encoded Image 135-1, IC2CP Encoded Image 135-2, . . . , IC2CP Encoded Image 135-m.

Then the IC2CP Encoded Image data structure collection 135 is stored along with the Trained Model 205 from FIG. 2 and an industry-standard Predict functional component 300 is applied. The Predict functional component 300 then produces a collection of predicted damage labeling data using the classifiers “no damage”, “minor damage”, “major damage”, and “total damage” of the Trained Model 205. This yields a corresponding predicted damage label data collection 303=Predicted Damage 303-1, Predicted Damage 303-2, . . . , Predicted Damage 303-m for each i, 1≤i≤m based on the original pre- and post-image data structures. The damage label can be used for immediate decision processes in, but not limited to, HADR/DA, military operations, as well as other civilian applications in agriculture, forestry, fire control, infrastructure systems health monitoring, and critical region safety/security in urban and rural regions of interest.

The IP2CL system and method described herein can be used for pixel-wise damage level assessments, and for patch-based damage level assessments.

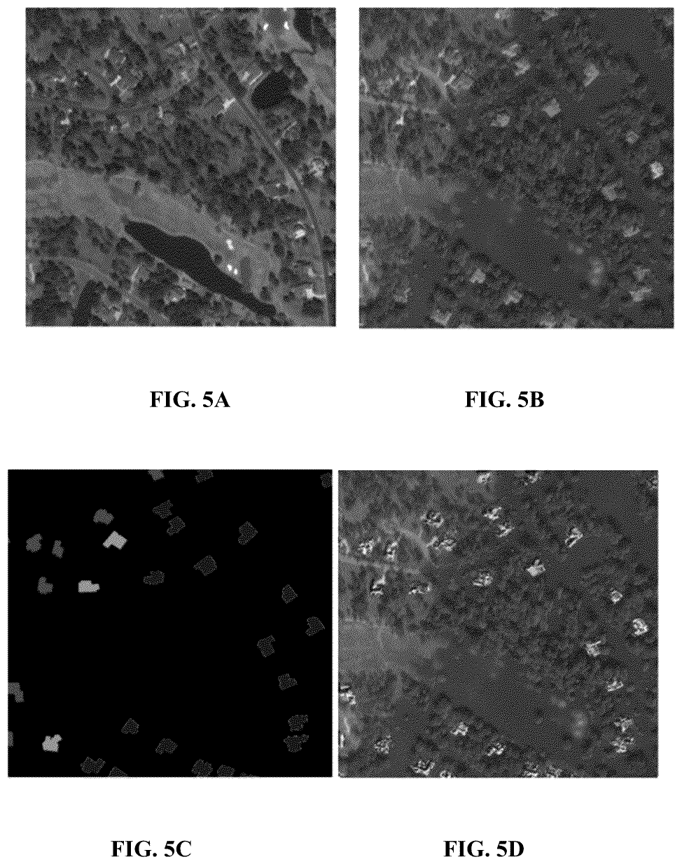

The first application uses FIGS. 1-3 for TOI segmentations to generate dense pixel-wise damage classification for possibly multiple TOIs. Here, an instance of initial testing for the IP2CP embodiment is summarized in Table 1 below comparing its performance in segmentation to several state-of-the-art industry standard segmentation tools. For images covering a wide expanse such as shown in FIGS. 5A and 5B, the semantic segmentation procedure is needed to generate dense pixel-wise damage classification for possibly multiple TOIs. For this concrete segmentation, the original prior and posterior images are the actual pre- and post-images represented by boxes in FIGS. 1-3, and the deep net model trained in FIG. 2 and applied in FIG. 3 is a UNet with possibly different choices of backbone deep net, such as a VGG-19 convolutional neural network or ResNet 19 residual neural network. The Unet consists of a convolution path and an up-convolution path, which gives it the u-shaped deep net architecture. It is a leading deep net used to resolve the segmentation problems.

FIG. 5C is a ground truth damage mask of the target of interest using the method of the present invention, which in this case, are the buildings in the TOI region. In the color code scheme in FIG. 5C: red represents no damage; green represents minor damage; blue represents major damage; and yellow represents total damage.

TABLE 1
Performance of pixel-wise segmentation: Precision, Recall and F1
scores, Run time (ms: millisecond), and Net size (MB: Mega Bytes)

| algorithm | Method 1 | Post-only | CCNY CL | IP2CL |
|---|---|---|---|---|
| Precision | 64.2 | 65.6 | 67.2 | 69.1 |
| Recall | 59.3 | 67.2 | 67.6 | 70.4 |
| F1 score | 61.7 | 66.4 | 67.4 | 69.7 |
| Run time (ms) | 660.9 | 102.6 | 520.4 | 103.2 |
| Net size (MB) | 441 | 9.7 | 40 | 9.7 |

In Table 1, the performance of the IP2CL method is tabulated showing that the IP2CL delivers consistently valuable performance across the board. In Table 1, the performance of IP2CL's pixel-wise segmentation capabilities are compared to three other state of the art segmentation systems. Method 1 is the result of reproducing the winning method in the original xView 2 challenge, sponsored by the Department of Defense's Defense Innovation Unit (DIU) in 2020, which explored how to assess disaster damage by using computer vision algorithms to analyze satellite imagery. The competition's Post-only algorithm is the Unet method using only the post-disaster images. CCNY CL is the City College of New York Contrastive Learning (or CLIFGAN) system described in “Deep Learning Approach for Data an Computing Efficient Situational Assessment and Awareness in Human Assistance and Disaster Response and Damage Assessment Applications”, Jie Wei, et al. published in AI/HADR workshop, NeurIPS 2021. As indicated in bold, the IP2CL outperforms all three compared methods in the industry standard user confidence metrics of precision, recall, and F1 scoring (described below). Furthermore, the IP2CL method nearly matches the fastest run time and smallest model size (Post-only system) making it decision speed compatible as well as edge deployable.

F1 is a standard user confidence metric in AI/ML modeling. F1 measures the model's sensitivity to false alarm in, for example, autonomous classification tasking. In AI/ML classification problems, there are two major evaluation metrics: precision and recall. Precision is the ratio of true positives over the sum of true positives and false positives, which focused on the correctness of the predictions; whereas recall is the ratio of true positives over the sum of true positives and false negatives, which focuses on the completeness of the predictions. F1 is the harmonic mean of precision and recall, yielding a balanced picture of the predictions.

Since the pixel-wise dense damage level classification was designed for large-area images, there is also a need for methods that focus on a smaller area (i.e., a “patch”). Examples of HADR/DA applications where a relatively small region requires more accurate results include responding to prioritized TOIs such as a school or hospital indicating damage and the need for immediate action. In these important first-responder scenarios, the dense pixel-wise damage level classification can be discarded since where the TOI is located requires only one classification label for the entire patch.

Two choices are made in generating the local patches: 1) instead of categorizing damage levels from “minor” up to “total”, a binary label “no damage” and “with damage” is adequate which avoids challenges associated with an extremely small number of “major” and “total” damage levels, and 2) instead of using the entire image as done for semantic segmentation for pixel-wise damage level assessment, the original large image is first cut into 64×64 small patches, and the “global label” for each small patch is “with damage” if the number of TOI pixels is more than half of the patch size, and “without damage” otherwise. In effect, instead of a pixel-wise damage level prediction task as in the previous use case, one only needs to train a model to produce a global label for the entire patch.

The same model training and application procedures as shown in FIGS. 2-3 are employed in this local patch classification task. To clarify the special nature of this task, FIG. 4 is provided. Although it details an algorithm for five TOIs and background patches in an original 2D image, it readily generalizes finitely many images, patches, and high-dimensional visual imagery. This generalization can be induced collectively from FIGS. 2-3 organizational designs when applied to FIG. 4.

FIG. 4 is a block diagram of the IP2CP local patch contrastive module detailing the local patch generations from the original images afterward calling on contrastive learning to embed the small images to a low-dimensional (two-dimensional or 2D in this case) space to create patches (1-5 as shown in FIG. 4) with TOI and without TOI (A-E in FIG. 4). The 64×64 patches in the original image are first isolated into the 64×64 Patches with TOI data structure collection 401 and 64×64 Patches without TOI data structure collection 402 using various visualization object identifiers such as state of the art YOLO versions. The number of patches in collections 401 and 402 is maintained with a similar count to ensure balanced datasets. From FIG. 2, system 100 executes in FIG. 4 (as a functional call in computer science terminology) generating the corresponding IP2CP representation for each patch. These patches are next ingested to train contrastive learning, the Contrastive Learning functional component 411, to put them into different locations in a 2D space, denoted as the Embedding Space in FIG. 4. The Contrastive Learning functional component 411 is trained as a contrastive net based on the following contrastive loss:

$${L}_{CL} = 1 [ {y}_{i} = {y}_{j} ] {‖ θ ( {x}_{i} - {x}_{j} ) ‖}_{2}^{2} + 1 [ {y}_{i} \neq {y}_{j} ] max ( 0 , ϵ - {‖ θ ( {x}_{i} - {x}_{j} ) ‖}_{2}^{2} ) \qquad ( 4 )$$

where 1[⋅] is the standard indicator function, xᵢ and xⱼ are two samples with associated labels yᵢ and yⱼ to be contrasted, θ is the encoding contrastive deep net, a three-layer Convolutional Neural Network (CNN) in this case, and ϵ is a hyper-parameter indicating the lower-bound distance for samples from different classes. For the given training datasets, similar samples are created by applying data augmentation, such as performing image translation, flipping, shearing, rotation, and color jittering, to make more samples of the same label (yᵢ's) available, hence generating sufficient training/testing data to achieve contrastive training effectively.

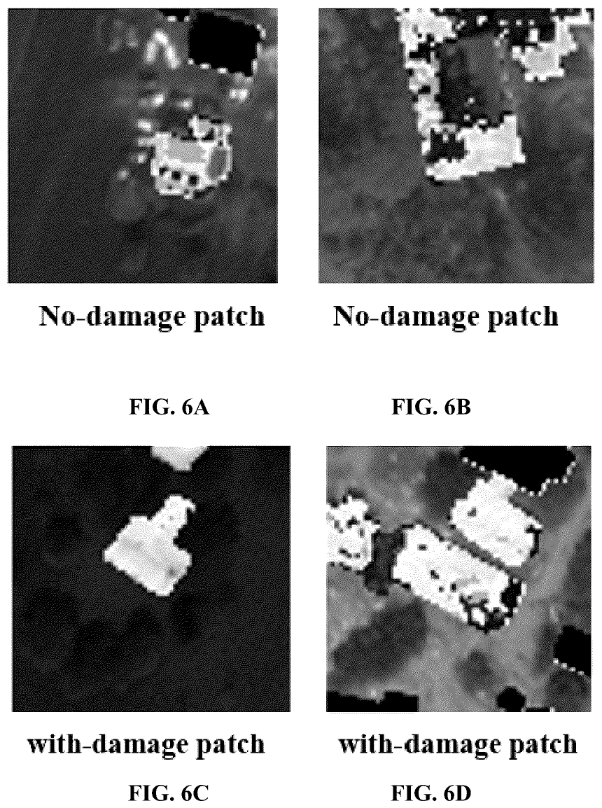

FIGS. 6A and 6B show two examples of IP2CP local patches with no damage in the TOI region that are used to train the contrastive learning net. FIGS. 6C and 6D are sample IP2CP local patch with damage designations in the TOI region that are used to train the contrastive learning net. In FIGS. 6A to 6D, the colors are created by differences in the foreground (Target of Interest), and do not have a specific meaning.

Table 2 reports the performance of the IP2CL system for the local patch classification task, where the IP2CL system again achieves the optimal performance for most criteria.

TABLE 2
Patch-based damage classification performances
using IP2CL and the net size

| | F1 | |
|---|---|---|
| Algorithms | score | Net size (K) |
| Contrastive learning (4-layer | 95.9 | 8,566 |
| CNN, 4-layer projection) | | |
| Visual transformer (ViT-b-16) | 95.0 | 343,261 |
| VGG19 | 94.2 | 558.326 |
| ResNet 152 | 93.0 | 233,503 |
| ResNet 101 | 92.7 | 170.643 |
| Inception v3 | 90.5 | 100,810 |
| googlenet | 90.3 | 22,585\| |

There are numerous, non-limiting embodiments of the invention. All embodiments, even if they are only described as being “embodiments” of the invention, are intended to be non-limiting (that is, there may be other embodiments in addition to these), unless they are expressly described as limiting the scope of the invention. Any of the embodiments described herein can also be combined with any other embodiments in any manner to form still other embodiments. For example, although the data used in the system and method described above are optical images (color images), other modalities such as Infra-Red or Near Infra-Red images can be used instead of, or in addition to, color images.

The resultant system reasoning as to why a certain damage level is obtained should provide sufficient evidence and justifications based on: (1) physical knowledge of the object such as a digital twin model of the infrastructure; (2) availability in near-real time (NRT) response for HADR personnel; and (3) configurability based on existing destruction confirming results to HADR personnel before making critical decisions.

It should be understood that, in some cases, some of the steps described herein may be optional. In some cases, additional steps can be added. The steps can also be performed in any suitable order. In some cases, some steps can be performed simultaneously, rather than sequentially. In other cases, steps describes as being performed simultaneously may be performed sequentially.

The system and method described herein can be used in many different situations including, but not limited to in military operations, in human assistance and disaster response efforts, and by businesses in agriculture, forestry, fire control, and safety/security to evaluate various situations in a data and computing efficient manner. Responses can include, but are not limited to: sending rescue personnel into areas (or into specific buildings, etc. within areas) that sustained damages; sending medical personnel to such locations; sending supplies such as food and water and temporary shelter; and sending construction personnel and construction supplies into damaged areas. In military operations, the system and method provide valuable help to assess battlefield damage levels. The data and computing efficiency can make it possible for military personnel (and others) to utilize the system and method with a simple computing device such as a laptop or a cell phone. In the case of military operations, this can allow military personnel to classify and/or identify one or more targets of interest such as to carry out future strikes on such targets. In the case of areas damaged by enemy fire, the system and method can be used to determine whether structures remain useful for their intended purpose(s), the extent of repair that is needed, and/or how much aid must be sent to those within such structures.

The system and method described herein can provide a number of advantages. It should be understood, however, that these advantages need not be required unless they are set forth in the appended claims.

The Image-based Prior and Posterior Conditional Probability (IP2CP) representation gives rise to a systematic IP2CP learning (IP2CL) approach. IP2CL is designed to transform two-image inputs to a single image input facilitating knowledge transfer via transfer learning offering higher-performance deep nets with better analysis. The IP2CL system is data and computing efficient as it reduces two color images that need to be processed to one thus significantly improving the computation and storage efficiency. The IP2CL system facilitates flexibility in choosing different deep learning methods: using the RGB channels, the ingested data to the deep nets are ordinary color images allowing more available deep nets trained on large data sets to be employed. Based on the new IP2CP representation, two different situations of practical interest to HADR are used. The first is for global semantic segmentation as originally done for HADR which identifies the damage levels for the entire image of every TOI aiding responder response to specified disasters. The second utilizes patch-based classification in HADR or DA-SAA. In this case, the TOIs are prescribed prioritization response levels. For example, hospitals or schools in HADR applications or enemy headquarters in DA are obviously of more importance so the high-accuracy damage assessment for these important regions is prioritized over say landfills or under-utilized regions. The IP2CL yields saliency on targets of interest. The stressed region of interest with larger values in the IP2CP representation puts more emphasis on the TOI regions. The IP2CL emulated human annotation process: expert users manually label the pixel-wise difference in TOI for labor-intensive damage level assessment. The IP2CL effectively exploits the context information for the TOI: the background in the post-images provides far more contextual information for TOI identification contained within the IP2CP representation.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A system for assessing infrastructure damage of a target of interest region, said system comprising:
a) a computing device configured to run an Image-based Prior and Posterior Conditional Probability (IP2CP) formulation to formulate conditional probabilities in the form of a normalized color image for global and local patch damage assessment work;
b) an IP2CP training module that is configured to ingest a collection of prior images and post images of the target of interest region, and then perform supervised deep learning (DL) multi-classification tasks under a prescribed random train/test split, said IP2CP training module providing an output;
c) an IP2CP application module that is configured to apply the IP2CP formulation using the output of the IP2CP training module to a given target of interest region, said IP2CP application module providing an output; and
d) an IP2CP local patch contrastive module that provides local patch damage level assessment of the given target of interest region based upon the output of the IP2CP application module.

2. A method for assessing infrastructure damage of a target of interest region, said method comprising:
a) obtaining a first image X of the target of interest region that is prior to a damage causing event, said first image having a first background;
b) obtaining a second image Y of the target of interest region that is after a damage causing event, wherein the second image is a matching image of the target of interest region, said second image having a second background;
c) encoding the differences and importance of the target of interest region into a single image Z; and
d) using deep learning for single image segmentation and classification to assess damage to the target of interest region.

3. The method of claim 2 wherein the damage causing event is a natural disaster.

4. The method of claim 2 wherein the damage causing event is a battlefield event.

5. The method of claim 2 wherein the first and second images are satellite images or aerial photographs taken by airplanes.

6. The method of claim 2 wherein the images X, Y, and Z are color images.

7. The method of claim 6 wherein image Z is a three-color image.

8. The method of claim 7 wherein image Z has a background that is derived from the background of image Y.

9. The method of claim 8 wherein image Z is generated from pre-image X and post-image Y, viewed as random variables with the following set of two conditional probability formulas:
$$P ( {Z}_{0} \vert {X}_{0} , {Y}_{0} ) = {Y}_{0} \qquad ( 1 )$$
$$P ( {Z}_{1} \vert {X}_{1} , {Y}_{1} ) = Norm ( {Y}_{1} - {X}_{1} ) \qquad ( 2 )$$
where X_{c} and Y_{c} are the pre-image and post-image with values in the range [0,1], subscript c is the image indicator variable: 0 for background, 1 for target of interest, Z_{c} is the new random variable of the same range as X and Y, and
$${Z}_{c} = Norm ( w ) = \frac{w}{max ( w ) - min ( w )} \qquad ( 3 )$$
is to bring the random variable of pixel (w) to the range [0,1].

10. The method of claim 2 wherein the single image segmentation and classification comprises pixel-wise semantic segmentation wherein damage levels are densely classified for each pixel of the target of interest.

11. The method of claim 2 wherein the single image segmentation and classification comprises patch-based global damage classification for a 64×64 resolution image patch centered around the target of interest where a single damage level is assigned for the entire patch.

12. The method of claim 12 wherein the single damage level is either “no damage” or “with damage”.

13. The method of claim 2 further comprising a step e) of providing assistance to the target of interest region based on the damage assessment.
